(19) United States
(12) Patent Application Publication
(10) Pub. No.: US 2009/0255258 A1
(43) Pub. Date: Oct. 15, 2009

(54) Pre-filming air-blast fuel injector having a reduced hydraulic spray angle

(75) Inventors: David H. Bretz, West Des Moines, IA (US); Spencer D. Pack, Urbandale, IA (US)

Correspondence Address: Scott D. Wofsy;EDWARDS ANGELL PALMER & DODGE LLP, P.O. Box 55874, Boston, MA, 02205, US

(73) Assignee: Delavan Inc, West Des Moines, IA (US)

(21) Appl. No.: 12/082,532

(22) Filed: Apr. 11, 2008

(51) Int. Cl. F02C 7/22

(52) U.S. Cl. 60/737

(57) ABSTRACT

An air-blast fuel injector is disclosed that includes an on-axis inner air circuit, a fuel circuit radially outboard of the inner air circuit, the fuel circuit having an axially converging pre-filming chamber and an axially diverging pre-filming surface extending from the pre-filming chamber to an exit annulus and an outer air circuit radially outboard of the fuel circuit communicating with the exit annulus of the axially diverging pre-filming surface.

### BACKGROUND OF THE INVENTION

1. Field of the Invention

The subject invention is directed to a fuel injector for a gas turbine engine, and more particularly, to a pre-filming air-blast fuel injector for a gas turbine engine having an axially extended pre-filming surface with a radially expanding profile configured to decrease hydraulic spray angle and fluid momentum of exiting fuel while maintaining effective atomization and mixing for improved engine power operability and combustion flame stability.

2. Description of Related Art

Pre-filming air-blast fuel injector nozzles for issuing atomized fuel into the combustor of a gas turbine engine are well known in the art. In this type of nozzle, fuel is spread out into a thin continuous sheet and then subjected to the atomizing action of high-speed air. More particularly, atomizing air flows through concentric air swirl passages that generate two separate swirling airflows at the nozzle exit. At the same time, fuel flows through a plurality of circumferentially disposed tangential ports and then onto a pre-filming surface where it spreads out into a thin uniform sheet before being discharged from the edge of the pre-filming surface into the cross-flowing air stream.

Because the cross-flowing air stream has a much higher kinetic energy it excites the lower kinetic energy fuel sheet. That interaction serves to shear and accelerate the fuel sheet, creating multiple modes of instability, which ultimately results in the fuel sheet breaking into ligaments of fuel. These fuel ligaments are similarly excited and broken into droplets. This is the primary mode of droplet formation, requiring that the cross-flowing air stream has sufficient energy to cause excitation. Typically, the fuel exit angle or hydraulic spray angle of a pre-filming air-blast atomization nozzle is 90° or greater, which effects the interaction shears and fuel acceleration. Thus, the fuel exit angle can be directly related to fuel break up and droplet size.

Control of the hydraulic spray angle, specifically the decrease of the hydraulic spray angle is of significant value in an air blast atomizer. Most air-blast atomizers attempt to control the hydraulic spray angle by controlling the swirl strength of the outer air swirler. These methods have very limited success in reducing the hydraulic spray angle while maintaining satisfactory combustion operating characteristics.

Importantly, the design of the nozzle tip controls the local free-stream turbulence levels, the three-dimensional velocity field, and the temperature of the fuel/air mixture immediately prior to combustion, all of which directly affect flame stability. The nozzle tip design is critical in that it determines how close the re-circulated exhaust gases come to the nozzle tip, which in turn controls the concentration of the highly reactive chemical species feeding into the combustion zone. By controlling the hydraulic spray angle, fuel nozzle designers can better match the air and fuel flow paths for improved combustion stability, combustion efficiency, emissions and combustor wall temperatures.

### SUMMARY OF THE INVENTION

The subject invention is directed to a new and useful pre-filming air-blast fuel injector for use in conjunction with gas turbine engines, which is adapted and configured to issue atomized fuel at a reduced hydraulic spray angle and with decreased momentum as compared to prior art pre-filming air-blast fuel injectors, while maintaining satisfactory combustion operating characteristics.

In this regard, the pre-filming air-blast fuel injector of the subject invention includes a nozzle body assembly having a fuel circuit forming a fuel swirler defined in part by angled swirl slots, an axially converging pre-filming chamber fed by the fuel swirler and an axially diverging (radially expanding) pre-filming surface that extends from the pre-filming chamber to an exit annulus.

The fuel injector of the subject invention further includes an on-axis inner air circuit radially inboard from the fuel circuit and an outer air circuit radially outboard from the fuel circuit. The outer air circuit communicates with the exit annulus of the axially diverging pre-filming surface. In operation, the inner and outer air circuits provide a cross-flowing air stream with high kinetic energy that excites the fuel sheet attached to the axially diverging pre-filming surface, shearing and accelerating the fuel sheet, creating instability and ultimately breaking the fuel sheet into ligaments which are further broken into small droplets downstream from the nozzle tip.

The inner air circuit preferably includes an inner air swirler and the outer air circuit preferably includes an outer air swirler. The inner and outer air swirlers can be configured as either axial air swirlers or radial air swirlers. In the case of an axial inner air swirler, the air swirler preferably has swirl vanes with a swirl angle of about 0° to 60° with respect to the axis of the inner air circuit. In one embodiment of the subject invention, the inner air circuit includes an inner air swirler that is co-rotational with respect to the rotational direction of the fuel swirler. In another embodiment of the invention, the inner air circuit includes an inner air swirler that is counter-rotational with the respect to the rotational direction of the fuel swirler.

The subject invention is also directed to an air-blast fuel injector including a nozzle body assembly defining a longitudinal axis and having a fuel swirler, wherein the fuel swirler communicates with a conical pre-filming chamber, wherein the conical pre-filming chamber communicates with a radially expanding pre-filming surface, and wherein the radially expanding pre-filming surface extends axially from the pre-filming chamber to an annular exit lip. Preferably, the radially expanding pre-filming surface has an exit angle of about between 10° and 15° with respect to the longitudinal axis of the nozzle body and a length of about between 0.300 and 0.400 inches as measured from the pre-filming chamber to the exit lip.

It is envisioned that the subject invention could be applied to any configuration of a pre-filming fuel injector, including, for example, piloted, hybrid, dual or pure air blast type injectors, where a reduced spray angle and decreased fuel momentum with improved engine performance as the desired result. This would also include pre-filming injectors having multiple inner and/or outer air circuits.

These and other features and benefits of the pre-filming air-blast fuel injector of the subject invention and the manner in which it is employed will become more readily apparent to those having ordinary skill in the art from the following enabling description of the preferred embodiments of the subject invention taken in conjunction with the several drawings described below.

### BRIEF DESCRIPTION OF THE DRAWINGS

So that those skilled in the art to which the subject invention appertains will readily understand how to make and use the fuel nozzle assembly of the subject invention without undue experimentation, preferred embodiments thereof will be described in detail herein below with reference to certain figures, wherein:

FIG. 1 is a side-elevational view, in cross-section, of a prior art pre-filming air-blast fuel injector having an axially converging pre-filming surface extending from the pre-filming chamber of the fuel circuit;

FIG. 2 is a is a perspective view, in partial cross-section, of a prior art pre-filming air-blast fuel injector as illustrated in FIG. 1;

FIG. 3 is a side-elevational view, in cross-section, of a pre-filming air-blast fuel injector constructed in accordance with a preferred embodiment of the subject invention, which has an axially diverging pre-filming surface extending from the pre-filming chamber of the fuel circuit; and

FIG. 4 is a perspective view, in partial cross-section, of the pre-filming air-blast fuel injector as illustrated in FIG. 3, showing the radially expanding pre-filming surface.

### DETAILED DESCRIPTION OF PREFERRED EMBODIMENTS

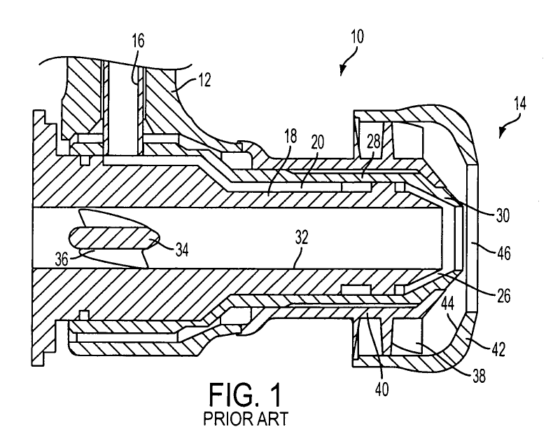

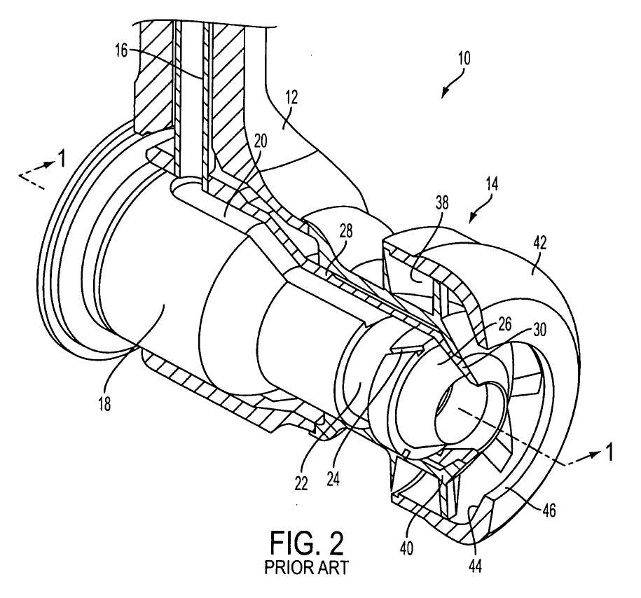

Referring now to the drawings, there is illustrated in FIGS. 1 and 2 an example of a typical prior art air-blast fuel injector designated generally by reference numeral 10. As shown, fuel injector 10 includes an elongated feed arm 12 and a nozzle body assembly 14 for issuing atomized fuel to a combustion chamber of a gas turbine engine. The feed arm 12 has a fuel feed tube 16 extending therethrough for delivering fuel to the nozzle body assembly 14.

The nozzle body assembly 14 includes a fuel swirler body 18 which defines a fuel circuit or pathway that includes a main fuel channel 20 which extends to an annular fuel chamber 22. A plurality of circumferentially disposed, tangentially oriented, angled swirl slots 24 extend from the annular fuel chamber 22 for delivering fuel to a conical pre-filming chamber 26. The angled swirl slots 24 are adapted and configured to impart angular momentum or a rotational component of velocity to the fuel delivered to pre-filming chamber 26.

Nozzle body assembly 14 further includes a pre-filmer 28 that surrounds the fuel swirler body 18 to form the outer boundary of the fuel circuit formed in the outer surface of fuel swirler body 18. The pre-filmer 28 includes an axially converging pre-filming surface 30 that extends downstream from the conical pre-filming chamber 26. During operation, the swirling fuel sheet formed in the pre-filming chamber attaches to the pre-filming surface 30 and spreads out into a thin uniform sheet before it is subjected to the atomizing action of high-speed air.

Nozzle body assembly 14 further includes an on-axis inner air circuit 32 that extends through the axial core of the fuel swirler body 18 to direct high-speed air across the exit lip of pre-filming surface 30. An inner air swirler 34 is disposed in the upstream region of the inner air circuit 32. The inner air swirler 34 has a plurality of swirl vanes 36 for imparting an angular component of velocity to the high speed air flowing therethrough.

Nozzle body assembly 14 also includes an outer air circuit 38, which is radially outboard from the fuel circuit and which his defined between an outer air swirler 40 and an outer air cap 42. Outer air cap 42 has a converging downstream wall 44, which forms the exit orifice 46 of the nozzle body assembly 14. As is typical, the hydraulic spray angle of the fuel issuing from the prior art nozzle body assembly 14 is generally controlled by the configuration of the outer air circuit 38, including the shape of the outer air cap 42 and the geometry of the outer air swirler 40.

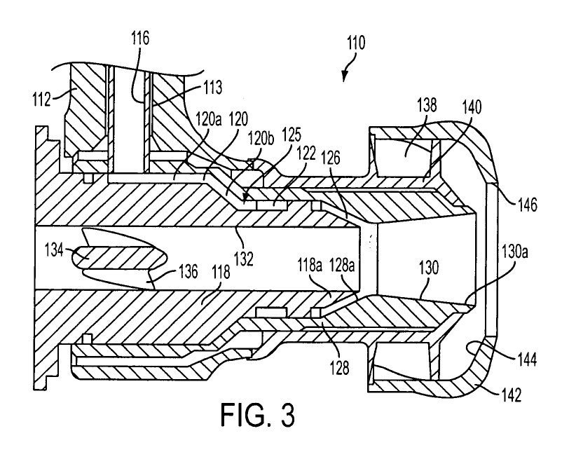

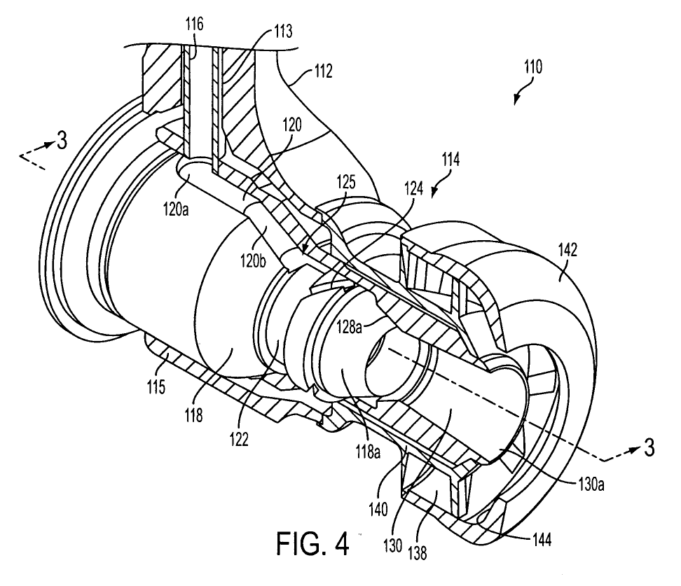

Referring now to FIGS. 3 and 4, there is illustrated a pre-filming air-blast fuel injector constructed in accordance with a preferred embodiment of the subject invention and designated generally by reference numeral 110. Fuel injector 110 includes a nozzle body assembly 114 that is adapted and configured to issue atomized fuel into the combustion chamber of a gas turbine engine with decreased fluid momentum and a reduced hydraulic spray angle, as compared to the prior art pre-filming air-blast fuel injector 10 illustrated in FIGS. 1 and 2. As explained in more detail below, this is accomplished by providing an axially extended pre-filming surface with a radially expanding profile.

With continuing reference to FIGS. 3 and 4, fuel injector 110 includes an elongated feed arm 112 having a through bore 113 containing an elongated fuel feed tube 116 for delivering fuel to the nozzle body 114. An insulating gap may be provided between the outer periphery of the fuel feed tube and the inner periphery of the bore 113 to thermally protect the fuel tube. The insulating gap may be filled with air or with an inert gas, such as, for example, argon.

An outer heat shield or shroud 115 extends from the feed arm 112 to surround and otherwise thermally protect the internal components of the nozzle body assembly 114. An insulating air gap may also be provided between the interior surface of shroud 115 and the interior components of the nozzle body assembly 114. It is envisioned that this gap could be in communication with the insulating gap provided in feed arm 112.

Nozzle body assembly 114 further includes a fuel swirler body 118 defining a fuel circuit 125 for receiving fuel from the fuel feed tube 116. The fuel circuit 125 includes a main fuel channel 120 which has an upper channel section 120a that extends from the fuel feed tube 116 to an inclined lower channel section 120b. The lower channel section 120b of fuel channel 120 communicates with an annular fuel chamber 122 that extends about the circumference of the fuel swirler body 118.

Fuel circuit 125 further includes a plurality of tangentially oriented, circumferentially disposed, angled fuel swirl slots 124, which extend from the annular fuel chamber 122 to a conical pre-filming chamber or spin chamber 126. The swirl slots 124 are adapted and configured to impart angular momentum or a rotational component of velocity to the fuel delivered into pre-filming chamber 126. This causes the fuel to rotate or spin within pre-filming chamber 126. The number of swirl slots 124 and the tangential orientation or angle of the slots can vary by design depending upon the engine application. For example, the number of swirl slots 124 can vary from three to six or more, while the angle of the swirl slots 124 can vary from 30° to 50° degrees or more. These variations tend to effect fuel break-up and atomization.

Nozzle body assembly 114 further includes a pre-filmer 128 that is radially outboard of the fuel swirler body 118 and substantially surrounds the fuel swirler body 118 in such a manner so as to enclose or otherwise provided an outer boundary for the fuel circuit 125 formed therein. The conical pre-filming chamber or spin chamber 126 is defined by the axially converging downstream surface 118a of fuel swirler body 118 together with the axially converging medial surface 128a of pre-filmer 128.

Pre-filmer 128 further includes an axially diverging (radially expanding) pre-filming surface 130 that extends downstream from the pre-filming chamber 126 to an annular exit lip 130a. The radially expanding pre-filming surface 130 is configured to decrease the hydraulic spray cone angle and fluid momentum of the fuel issuing from nozzle body assembly 114, as compared to prior art air-blast nozzles of the type shown in FIG. 1, while still maintaining effective fuel atomization and air/fuel mixing.

It is envisioned that multiple spray angles and different flow fields can be developed based upon the needs of the specific combustion system requirements, by altering the length of the pre-filming surface 130 and the pre-filmer exit angle at exit lip 130a. For example, in an exemplary embodiment of the fuel injector 110 of the subject invention, it is envisioned that pre-filming surface 130 can extend to a length of about 0.300 to about 0.400 as measured from the pre-filming chamber to the exit lip 130a, and the pre-filmer exit angle can be about between 10° and 15° with respect to the axial centerline of the nozzle body 114.

Nozzle body assembly 114 further includes an on-axis inner air circuit 132 that extends through the axial core of fuel swirler body 118 to direct high speed air toward the exit lip 130a of pre-filming surface 130. The inner air circuit 132 and fuel circuit 125 are configured such that the fuel injection point is located axially upstream of the nozzle exit, which increases interaction time, which promotes fuel air mixing while decreasing the atomizer spray angle.

An inner air swirler 134 is disposed in the inner air circuit 132. The inner air swirler 134 has a plurality of swirl vanes 136 for imparting an angular component of velocity to the air flowing therethrough. More particularly, the inner air circuit 132 is designed to take pressure drop across the region where the fuel enters the air stream so that the air velocity across the fuel film attached to the pre-filming surface 130 is accelerated for more effective atomization and mixing. Furthermore, the air swirler 134 creates an expanding vortex as the air exits the fuel nozzle 114. The swirling air entrains fuel with it, and the resulting volumetric expansion of the vortex further strains the fuel sheet, aiding in shearing the fuel sheet into droplets.

Moreover, the accelerated air flow from the inner air circuit 132 is utilized for increased atomization at low power engine operation, concentrating a higher amount of velocity into the passing air current, which consequently produces smaller fuel droplet sizes. This in turn aids in combustion initiation and combustion stabilization. The accelerated inner air flow also controls how re-circulated exhaust gases are mixed with air and fuel flowing from the nozzle tip, ultimately creating an aerodynamically stable shear zone downstream from the nozzle tip suitable for combustion over a wide range of engine operating conditions.

While the inner air circuit 132 of nozzle body assembly 114 is shown as having only a single air passage, it is envisioned that the inner circuit 132 of nozzle body assembly 114 could have multiple air passages, each with its own air swirler. It is further envisioned that these multiple air paths can be co-rotational or counter-rotational with respect to one another. It is also envisioned that the inner air swirler 134 can be either of an axial geometry, as shown, or it can have a radial geometry. In the case of an axial air swirler, the number and angle of the swirl vanes can vary. For example, the number of vanes can vary between three and five and the angle of the vanes can range from 0° to 60° with respect to the axis of the swirler. It also envisioned that the direction of the swirling inner air flow can be either co-rotating or counter-rotating relative to the swirl direction of the fuel circuit.

Nozzle body assembly 114 also includes an outer air circuit 138 radially outboard of the fuel circuit 125 and defined between an outer air swirler 140 and an outer air cap 142. The outer air cap 142 has a converging downstream wall 144, which forms the exit orifice 146 of nozzle body assembly 114. The outer air circuit 138 can be of the axial style as shown, or of the radial style, and it is designed such that the outer air flow contains and atomizes the fuel sheet issuing from pre-filming surface 130. It is also envisioned that multiple outer air circuits can be provided in nozzle body assembly 114, each with its own air swirler. It is further envisioned that these multiple air paths can be co-rotational or counter-rotational with respect to one another.

As best seen in FIG. 3, the conical fuel annulus defined by the pre-filming chamber 126 is moved axially upstream relative to that of the prior art air-blast fuel nozzle 10 shown in FIG. 1. This allows earlier interaction between the fuel and the swirling air from the inner air circuit 132. It is also readily apparent that while the pre-filming surface 130 is axially extended relative to the prior art fuel nozzle shown in FIG. 1, both fuel nozzles 10 and 110 maintain the same exit plane, and are thus readily interchangeable for engine upgrades.

Importantly, the axially extended, diverging pre-filming surface 130 has a shallow angle (10° to 15°) to allow the fuel film to remain attached to the surface for a longer period of time. In addition, the extended pre-filming surface 130 allows the swirling fuel sheet to decrease in momentum. This decrease in momentum and the angle of the pre-filmer exit lip 130a serve to decreases the fuel exit angle. Those skilled in the art will readily appreciate however, that the pre-filmer exit angle can be varied to control the fuel spray angle depending upon the engine application.

In sum, there are a number of possible benefits that arise out of extending the pre-filming surface of the fuel circuit including, but not limited to, a reduced fuel spray angle, decreased fuel momentum, fuel and inner air pre-mixing, increased fuel and air shear and improved fuel atomization. It has also been determined that the extended pre-filming surface allows for good sheeting at low fuel flow rates, for example, down to 10 pph. This allows atomization to occur at extremely low pressure drops (˜0.1%).

While the axially extended, radially expanding pre-filming surface of the subject invention, has been shown and described in conjunction with a pre-filming air-blast fuel injector, it is envisioned that this technology could be applied to any type of pre-filming injector where a reduced spray angle and decreased fuel momentum with improved engine performance as the desired result. Examples include pre-filming piloted fuel injectors, pre-filming hybrid fuel injectors, pre-filming dual fuel injectors or pure air-blast fuel injectors.

Thus, while the fuel nozzle assembly of the subject invention has been described with respect to preferred embodiments, those skilled in the art will readily appreciate that changes and modifications may be made thereto without departing from the spirit and scope of the subject invention as defined by the appended claims.

What is claimed is:

1. An air-blast fuel injector comprising:
a) an on-axis inner air circuit;
b) a fuel circuit radially outboard of the inner air circuit, the fuel circuit having an axially converging pre-filming chamber and an axially diverging pre-filming surface extending from the pre-filming chamber to an exit annulus; and
c) an outer air circuit radially outboard of the fuel circuit communicating with the exit annulus of the axially diverging pre-filming surface.

2. An air-blast fuel injector as recited in claim 1, wherein the inner air circuit is upstream from and axially aligned with the pre-filming surface.

3. An air-blast fuel injector as recited in claim 1, wherein the outer air circuit converges toward the exit annulus of the pre-filming surface.

4. An air-blast fuel injector as recited in claim 1, wherein the outer air circuit includes an outer air swirler.

5. An air-blast fuel injector as recited in claim 1, wherein the inner air circuit includes an inner air swirler.

6. An air-blast fuel injector as recited in claim 5, wherein the inner air swirler is an axial swirler.

7. An air-blast fuel injector as recited in claim 5, wherein the inner air swirler is a radial air swirler.

8. An air-blast fuel injector as recited in claim 5, wherein the inner air swirler has swirl vanes with a swirl angle from about 0° to 60° with respect to the axis of the inner air circuit.

9. An air-blast fuel injector as recited in claim 1, wherein the fuel circuit includes a fuel swirler communicating with the pre-filming chamber.

10. An air-blast fuel injector as recited in claim 9, wherein the inner air circuit includes an inner air swirler that is co-rotational with respect to the fuel swirler.

11. An air-blast fuel injector as recited in claim 9, wherein the inner air circuit includes an inner air swirler that is counter-rotational with the respect to the fuel swirler.

12. An air-blast fuel injector as recited in claim 9, wherein the fuel swirler includes a plurality of circumferentially spaced apart, tangentially oriented angled fuel slots.

13. An air-blast fuel injector as recited in claim 1, wherein the axially diverging pre-filming surface has an exit angle of about between 10° and 15° with respect to the longitudinal axis of the nozzle body.

14. An air-blast fuel injector as recited in claim 1, wherein the axially diverging pre-filming surface has a length of about between 0.300 and 0.400 inches as measured from the pre-filming chamber to the exit annulus.

15. An air-blast fuel injector comprising:
a nozzle body assembly defining a longitudinal axis and having a fuel swirler, wherein the fuel swirler communicates with a conical pre-filming chamber, wherein the pre-filming chamber communicates with a radially expanding pre-filming surface, and wherein the pre-filming surface extends axially from the pre-filming chamber to an exit lip.

16. An air-blast fuel injector as recited in claim 15, wherein the conical pre-filming chamber is axially converging.

17. An air-blast fuel injector as recited in claim 15, wherein the nozzle body assembly includes an axially extending inner air circuit located upstream from the radially expanding pre-filming surface.

18. An air-blast fuel injector as recited in claim 17, wherein the inner air circuit includes an inner air swirler.

19. An air-blast fuel injector as recited in claim 18, wherein the inner air swirler is co-rotational with respect to the fuel swirler.

20. An air-blast fuel injector as recited in claim 18, wherein the inner air swirler is counter-rotational with the respect to the fuel swirler.

21. An air-blast fuel injector as recited in claim 18, wherein the inner air swirler has swirl vanes with a swirl angle from about 0° to 60° with respect to the axis of the inner air circuit.

22. An air-blast fuel injector as recited in claim 15, further comprising an outer air cap defining an outer air circuit that converges toward the exit lip of the pre-filming surface.

23. An air-blast fuel injector as recited in claim 22, wherein the outer air circuit includes an outer air swirler.

24. An air-blast fuel injector as recited in claim 15, wherein the fuel swirler includes a plurality of circumferentially spaced apart, tangentially oriented angled fuel slots.

25. An air-blast fuel injector as recited in claim 15, wherein the radially expanding pre-filming surface has an exit angle of about between 10° and 15° with respect to the longitudinal axis of the nozzle body.

26. An air-blast fuel injector as recited in claim 15, wherein the radially expanding pre-filming surface has a length of about between 0.300 and 0.400 inches as measured from the pre-filming chamber to the exit lip.
